(19) United States
(12) Patent Application Publication
(10) Pub. No.: US 2021/0357979 A1
(43) Pub. Date: Nov. 18, 2021

(54) PROVISION DEVICE, PROVISION METHOD, AND NON-TRANSITORY COMPUTER READABLE STORAGE MEDIUM

(71) Applicant: Yahoo Japan Corporation, Tokyo (JP)

(72) Inventors: Kota TSUBOUCHI, Tokyo (JP); Teruhiko TERAOKA, Tokyo (JP); Hidehito GOMI, Tokyo (JP); Junichi SATO, Tokyo (JP)

(21) Appl. No.: 17/198,090

(22) Filed: Mar. 10, 2021

(30) Foreign Application Priority Data
Mar. 19, 2020 (JP) 2020-050260

(51) Int. Cl. G06Q 30/02; G06K 9/00

(52) U.S. Cl. CPC G06Q 30/0261; G06K 9/00664

(57) ABSTRACT

A provision apparatus according to the present application includes an acquisition unit configured to acquire detected information based on information (information detected by an image sensor or a sound sensor) detected by a predetermined detection apparatus (for example, a spectacle type or ear-worn type wearable device worn by the user), a generation unit configured to generate changed information in which a detection result regarding a predetermined target is changed in the detected information in a case where context based on the detected information satisfies a predetermined condition, and a provision unit configured to provide the changed information to a user.

### CROSS-REFERENCE TO RELATED APPLICATION(S)

The present application claims priority to and incorporates by reference the entire contents of Japanese Patent Application No. 2020-050260 filed in Japan on Mar. 19, 2020.

### BACKGROUND OF THE INVENTION

### 1. Field of the Invention

The present invention relates to a provision apparatus, a provision method, and a non-transitory computer readable storage medium.

### 2. Description of the Related Art

In recent years, exponential spread of the Internet and improvement in distribution technologies have enabled a wide variety of content to be browsed through the Internet. As an example of such content, a technology called augmented reality (AR) is known. In such an AR technology, for example, a technology of displaying an advertisement on a scenery image captured by a mobile terminal apparatus is known.

However, with the above-described technology, it cannot be said that appropriate information is provided to a user.

For example, the above-described technology merely displays an advertisement selected on the basis of user information and ambient environment information of the mobile terminal apparatus in a predetermined advertisement display region within the scenery image, and it cannot be said that information appropriate for a scenery image displayed at the mobile terminal apparatus is provided to the user.

### SUMMARY OF THE INVENTION

It is an object of the present invention to at least partially solve the problems in the conventional technology.

A provision apparatus according to the present application includes an acquisition unit configured to acquire detected information based on information detected by a predetermined detection apparatus, a generation unit configured to generate changed information in which a detection result regarding a predetermined target is changed in the detected information in a case where context based on the detected information satisfies a predetermined condition, and a provision unit configured to provide the changed information to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWING

FIG. 1 is a view illustrating an example of provision processing according to an embodiment;

FIG. 2 is a view illustrating a configuration example of an information provision apparatus according to the embodiment;

FIG. 3 is a view illustrating an example of a policy information database according to the embodiment;

FIG. 4 is a flowchart illustrating an example of procedure of the provision processing according to the embodiment; and

FIG. 5 is a hardware configuration diagram illustrating an example of a computer which implements functions of the information provision apparatus.

### DETAILED DESCRIPTION OF THE PREFERRED EMBODIMENT

A mode for implementing a provision apparatus, a provision method, and a non-transitory computer readable storage medium according to the present application (hereinafter, referred to as an “embodiment”) will be described in detail below with reference to the drawings. Note that this embodiment does not limit the provision apparatus, the provision method, and the non-transitory computer readable storage medium according to the present application. Further, the same reference numerals will be assigned to the same portions in the following respective embodiments, and overlapped explanation will be omitted.

### 1. Embodiment

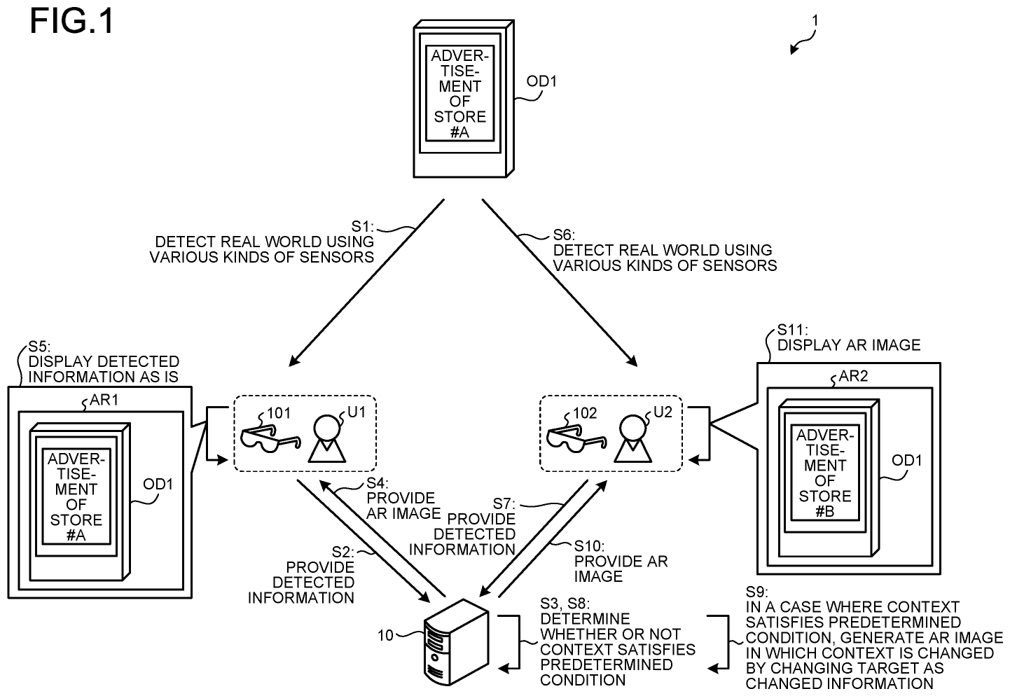

Provision processing to be implemented by a provision apparatus, or the like, of the present embodiment will be described using FIG. 1. FIG. 1 is a view illustrating an example of the provision processing according to the embodiment. Note that it is assumed in FIG. 1 that the provision processing according to the embodiment is implemented by an information provision apparatus 10 which is an example of the provision apparatus according to the present application.

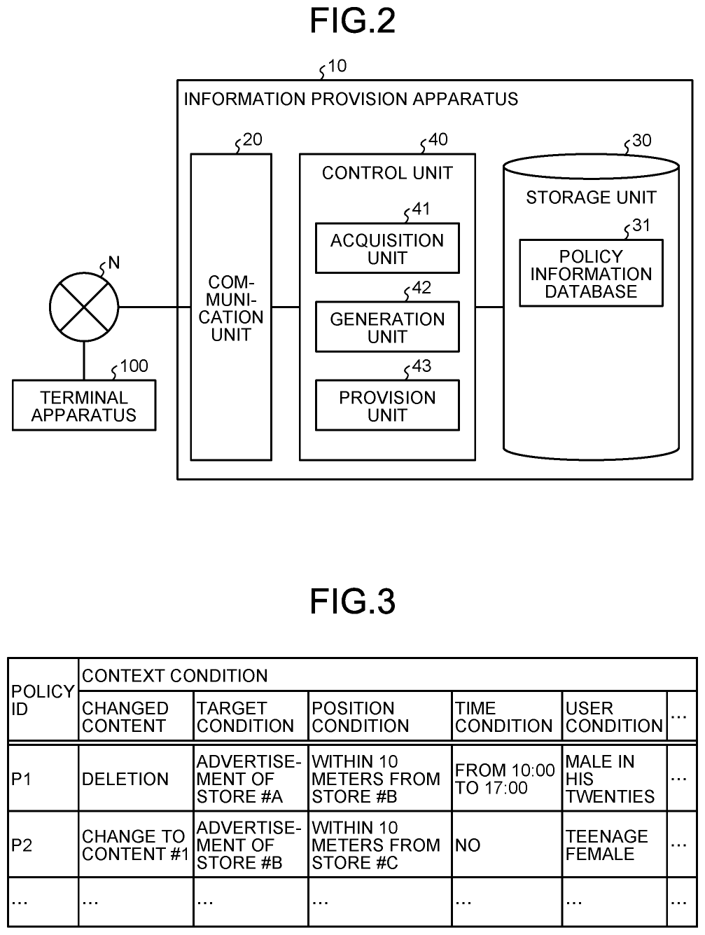

As illustrated in FIG. 1, a provision system 1 according to the embodiment includes the information provision apparatus 10, a terminal apparatus 101, and a terminal apparatus 102 (hereinafter, the terminal apparatus 101 and the terminal apparatus 102 will be sometimes collectively referred to as a “terminal apparatus 100”). The information provision apparatus 10 and the terminal apparatus 100 are connected to each other in a wired or wireless manner via a network N (see, for example, FIG. 2) so as to be able to perform communication. The network N is, for example, a wide area network (WAN) such as the Internet. Note that the provision system 1 illustrated in FIG. 1 may include a plurality of information provision apparatuses 10 and a plurality of terminal apparatuses 100.

The information provision apparatus 10 illustrated in FIG. 1, which is an information processing apparatus which performs provision processing, is implemented with, for example, a server apparatus or a cloud system. For example, the information provision apparatus 10 accepts submission of an advertisement and setting of policy information indicating various kinds of context which are advertisement provision conditions, and provides a corresponding advertisement to a user on the basis of the policy information. Note that in the following description, context indicated in the policy information indicates context of a target on which an advertisement is to be displayed (in other words, advertisement space) (such as a position of the target and content displayed on the target), context of a user to whom an advertiser wants to browse the advertisement (such as position information, a demographic attribute and a psychographic attribute), or the like.

The terminal apparatus 100 illustrated in FIG. 1 is an information processing apparatus to be used by the user. For example, the terminal apparatus 100 is a spectacle type or ear-worn type wearable device worn by the user and outputs detected information detected by various kinds of sensors (for example, an image sensor (camera), a sound sensor (microphone), a global positioning system (GPS) sensor) to an output unit (for example, a display or a speaker) provided at the terminal apparatus 100. Further, the terminal apparatus 100 outputs information delivered from the information provision apparatus 10 using web browser or application. Note that it is assumed in the example illustrated in FIG. 1 that the terminal apparatus 100 is a spectacle type wearable device having a camera which captures an image of a portion beyond the user's line of sight (in other words, the user's field of view) and displays the captured image (moving image) within sight of the user in real time.

The provision processing to be performed by the information provision apparatus 10 will be described below using FIG. 1. Note that an example will be described in the following description where the terminal apparatus 101 is used by a user U1 and the terminal apparatus 102 is used by a user U2. Further, in the following description, there is a case where the terminal apparatus 101 is equated with the user U1, and the terminal apparatus 102 is equated with the user U2. In other words, in the following description, the user U1 can read the terminal apparatus 101, and the user U2 can read the terminal apparatus 102.

Further, it is assumed in the following description that an advertisement regarding a store #A (hereinafter, sometimes described as an “advertisement #A”) is displayed on digital signages OD1 provided across the city. Further, it is assumed in the following description that the information provision apparatus 10 accepts submission of an advertisement regarding a store #B (hereinafter, sometimes described as an “advertisement #B”) and setting of policy information regarding the advertisement #B from a manager of the store #B.

First, the terminal apparatus 101 detects the real world using various kinds of sensors (step S1). For example, the terminal apparatus 101 captures an image including the digital signage OD1 (hereinafter, sometimes described as an “image #1”) using the camera.

Subsequently, the terminal apparatus 101 provides detected information indicating information detected using the sensor to the information provision apparatus 10 (step S2). For example, the terminal apparatus 101 provides the image #1 and information regarding the user U1 held by the terminal apparatus 101 (for example, an identifier for identifying the user U1, a demographic attribute, a psychographic attribute) to the information provision apparatus 10 as detected information #1.

Subsequently, the information provision apparatus 10 determines whether or not context based on the detected information satisfies a predetermined condition (step S3). Here, it is assumed in the example in FIG. 1 that the policy information of the advertisement #B indicates “display of the advertisement regarding the store #A” as context of a target on which the advertisement is to be displayed, and indicates “teenage female” as context of a user to whom the advertiser wants to browse the advertisement #B. In this case, the information provision apparatus 10 determines whether or not the image #1 includes the advertisement regarding the store #A using an arbitrary image recognition technology and determines whether or not the user U1 is a “teenage female” on the basis of information regarding the user U1 (or information collected by the information provision apparatus 10 on the basis of the information regarding the user U1). Note that it is assumed in the example in FIG. 1 that the information provision apparatus 10 determines that the user U1 is not a “teenage female” and the context based on the detected information #1 does not satisfy conditions indicated in the policy information of the advertisement #B.

Subsequently, the information provision apparatus 10 provides an AR image to the terminal apparatus 101 (step S4). For example, the information provision apparatus 10 provides the AR image (image AR1) indicating the same content as the image #1 to the terminal apparatus 101.

Then, the terminal apparatus 101 displays the detected information as is (step S5). For example, the terminal apparatus 101 displays the image AR1 indicating the same content as the image #1 to the user U1.

Then, similarly to the terminal apparatus 101, the terminal apparatus 102 detects the real world using various kinds of sensors (step S6). For example, the terminal apparatus 102 captures an image including the digital signage OD1 (hereinafter, sometimes described as an “image #2”) using the camera.

Subsequently, the terminal apparatus 102 provides detected information indicating information detected using the sensor to the information provision apparatus 10 (step S7). For example, the terminal apparatus 102 provides the image #2 and information regarding the user U2 held by the terminal apparatus 102 (for example, an identifier for identifying the user U2, a demographic attribute, a psychographic attribute) to the information provision apparatus 10 as detected information #2.

Subsequently, the information provision apparatus 10 determines whether or not context based on the detected information satisfies a predetermined condition (step S8). For example, the information provision apparatus 10 determines whether or not the image #2 includes the advertisement regarding the store #A using an arbitrary image recognition technology and determines whether or not the user U2 is a “teenage female” on the basis of information regarding the user U2 (or information collected by the information provision apparatus 10 on the basis of the information regarding the user U2). Note that it is assumed in the example in FIG. 1 that the information provision apparatus 10 determines that the image #2 includes the advertisement #A and the user U2 is a “teenage female”, and that the context based on the detected information #2 satisfies conditions indicated in the policy information of the advertisement #B.

Subsequently, the information provision apparatus 10 generates an AR image for which context is changed by changing a target as changed information in a case where the context based on the detected information satisfies a predetermined condition (step S9). For example, the information provision apparatus 10 generates an AR image (image AR2) for which context indicated by an image #2 (in other words, detected world (sensed reality) constructed from the detected information #2) is changed by changing the advertisement #A displayed on the digital signage OD1 included in the image #2 to the advertisement #B.

Subsequently, the information provision apparatus 10 provides an AR image to the terminal apparatus 102 (step S10). For example, the information provision apparatus 10 provides the generated image AR2 to the terminal apparatus 102.

Subsequently, the terminal apparatus 102 displays the AR image (step S11). For example, the terminal apparatus 102 displays the image AR2 to the user U2.

Note that various conditions other than those described in the example in FIG. 1 may be set as the conditions indicated by the policy information set by the advertiser. An embodiment in a case where policy information different from that described in the example in FIG. 1 is set for the advertisement #B will be described below.

It is assumed in the following description that the manager of the store #A (real store) displays the advertisement #A on a digital signage OD2 provided near the store #A and on a digital signage OD3 provided near the store #B (real store).

First, the terminal apparatus 101 detects the real world using various kinds of sensors. For example, the terminal apparatus 101 captures an image including the store #A and the digital signage OD2 (hereinafter, sometimes described as an “image #3”) provided in front of the store #A using the camera.

Subsequently, the terminal apparatus 101 provides detected information indicating information detected using the sensor to the information provision apparatus 10. For example, the terminal apparatus 101 provides the image #3 and position information indicating a position where the image #3 is captured to the information provision apparatus 10 as detected information #3.

Subsequently, the information provision apparatus 10 determines whether or not context based on the detected information satisfies a predetermined condition. Here, it is assumed in the present description that the policy information of the advertisement #B indicates “advertisement regarding the store #A, for which an image is captured within a predetermined range (for example, within 10 meters) from the store #B” as context of a target on which the advertisement is to be displayed. In this case, the information provision apparatus 10 determines whether or not the image #3 includes the advertisement regarding the store #A using an arbitrary image recognition technology and determines whether or not the position where the image #3 is captured is within a predetermined range from the store #B. Note that it is assumed in the present description that the information provision apparatus 10 determines that the position where the image #3 is captured is outside the predetermined range from the store #B and the context based on the detected information #3 does not satisfy conditions indicated in the policy information of the advertisement #B.

Subsequently, the information provision apparatus 10 provides an AR image to the terminal apparatus 101. For example, the information provision apparatus 10 provides the AR image (image AR3) indicating the same content as the image #3 to the terminal apparatus 101.

Then, the terminal apparatus 101 displays the detected information as is. For example, the terminal apparatus 100 displays the image AR3 indicating the same content as the image #3 to the user U1.

Then, the terminal apparatus 101 continuously detects the real world using various kinds of sensors. For example, the terminal apparatus 101 captures an image including the store #B and the digital signage OD3 (hereinafter, sometimes described as an “image #4”) provided in front of the store #B using the camera depending on the moving of the user U1.

Subsequently, the terminal apparatus 101 provides detected information indicating information detected using the sensor to the information provision apparatus 10. For example, the terminal apparatus 101 provides the image #4 and position information indicating a position where the image #4 is captured to the information provision apparatus 10 as detected information #4.

Subsequently, the information provision apparatus 10 determines whether or not context based on the detected information satisfies a predetermined condition. For example, the information provision apparatus 10 determines whether or not the image #4 includes the advertisement regarding the store #A using an arbitrary image recognition technology and determines whether or not the position where the image #4 is captured is within a predetermined range from the store #B. Note that it is assumed in the present description that the information provision apparatus 10 determines that the image #4 includes the advertisement #A, and the position where the image #4 is captured is within the predetermined range from the store #B, and determines that the context based on the detected information #4 satisfies conditions indicated in the policy information of the advertisement #B.

Subsequently, the information provision apparatus 10 generates an AR image for which context is changed by changing a target as changed information in a case where the context based on the detected information satisfies a predetermined condition. For example, the information provision apparatus 10 generates an AR image (image AR4) for which context indicated by an image #4 is changed by changing the advertisement #A displayed on the digital signage OD3 included in the image #4 to the advertisement #B.

Subsequently, the information provision apparatus 10 provides an AR image to the terminal apparatus 101. For example, the information provision apparatus 10 provides the generated image AR4 to the terminal apparatus 101.

Subsequently, the terminal apparatus 101 displays the AR image. For example, the terminal apparatus 101 displays the image AR4 to the user U1.

As described above, the information provision apparatus 10 according to the embodiment causes the terminal apparatus 100 to display an advertisement of an advertiser in place of a predetermined target included in detected information in a case where context based on the detected information captured by the terminal apparatus 100 satisfies conditions set by the advertiser. This enables the information provision apparatus 10 according to the embodiment to arbitrarily change display content of an advertisement on the basis of the conditions set by the advertiser in augmented reality even if the display content of the advertisement is fixed in the real world, and provide the display content to the user. In other words, the information provision apparatus 10 according to the embodiment can provide appropriate information which conforms to the policy of the advertiser to the user.

Further, the information provision apparatus 10 according to the embodiment acquires information regarding the real world (reality) detected by various kinds of sensors as detected information and constructs a detected world (sensed reality) from the acquired detected information. The information provision apparatus 10 then provides a world (diminished reality) in which targets which satisfy a predetermined condition are deleted, changed or made less likely to be recognized among various kinds of targets included in the detected world (corresponding to the targets in the real world) to the user using various kinds of provision means. As a result, the information provision apparatus 10 according to the embodiment can exclude information which the user does not desire to recognize or which is not desired to be recognized by the user from targets to be recognized by the user.

### 2. Configuration of Information Provision Apparatus

A configuration of the information provision apparatus 10 will be described next using FIG. 2. FIG. 2 is a view illustrating a configuration example of the information provision apparatus according to the embodiment. As illustrated in FIG. 2, the information provision apparatus 10 includes a communication unit 20, a storage unit 30, and a control unit 40.

Communication Unit 20

The communication unit 20 is implemented with, for example, a network interface card (NIC) or the like. Further, the communication unit 20 is connected to the network N in a wired or wireless manner and transmits and receives information to and from the terminal apparatus 100 or the like.

Storage Unit 30

The storage unit 30 is implemented with, for example, a semiconductor memory device such as a random access memory (RAM) and a flash memory, or a storage device such as a hard disk and an optical disk. As illustrated in FIG. 2, the storage unit 30 includes a policy information database 31.

Policy Information Database 31

The policy information database 31 stores policy information accepted from the advertiser. Here, an example of information stored in the policy information database 31 will be described using FIG. 3. FIG. 3 is a view illustrating an example of the policy information database according to the embodiment. In the example in FIG. 3, the policy information database 31 has items such as “policy ID” and “context condition”.

The “policy ID” indicates identification information for identifying policy information. The “context condition” indicates various kinds of context which are advertisement provision conditions and has items such as “changed content”, “target condition”, “position condition”, “time condition” and “user condition”. The “changed content” indicates change processing to be performed on detected information which satisfies the conditions. The “target condition” indicates a target on which the advertiser desires to perform change processing. The “position condition” indicates a position (area) at which the advertiser desires to perform change processing. The “time condition” indicates time (period) at which the advertiser desires to perform change processing. The “user condition” indicates a user to whom the advertiser is to provide the advertisement.

In other words, FIG. 3 illustrates an example where the context conditions of the policy information identified with a policy ID “P1” indicate that the changed content is “deletion”, the target condition is “advertisement of the store #A”, the position information is “within 10 meters from the store #B”, the time condition is “from 10:00 to 17:00”, and the user condition is “male in his twenties”.

Control Unit 40

The control unit 40, which is a controller, is implemented by, for example, a central processing unit (CPU), a micro processing unit (MPU), or the like executing various kinds of programs stored in a storage apparatus inside the information provision apparatus 10 using a RAM as a work area. Further, the control unit 40, which is a controller, is implemented with, for example, an integrated circuit such as an application specific integrated circuit (ASIC) and a field programmable gate array (FPGA). As illustrated in FIG. 2, the control unit 40 according to the embodiment includes an acquisition unit 41, a generation unit 42, and a provision unit 43, and implements or executes functions and actions of information processing which will be described below.

Acquisition Unit 41

The acquisition unit 41 acquires detected information based on information detected by a predetermined detection apparatus. For example, in the example in FIG. 1, the acquisition unit 41 acquires detected information based on information detected by the terminal apparatus 100 used by the user U1 using various kinds of sensors.

Further, the acquisition unit 41 may acquire a captured image of a target included in the user's field of view as the detected information. For example, in the example in FIG. 1, the acquisition unit 41 acquires an image captured with a camera which captures an image of a portion beyond the user's line of sight from the terminal apparatus 100.

Generation Unit 42

The generation unit 42 generates changed information by changing a detection result regarding a predetermined target in the detected information in a case where the detected information includes the detection result regarding the predetermined target. In other words, the generation unit 42 may generate changed information by changing the detection result regarding the predetermined target in the detected information in a case where context based on the detected information satisfies a predetermined condition. For example, in a case where the detected information includes a detection result regarding a target which is against public policy, the generation unit 42 generates changed information by changing the detection result regarding the target in the detected information.

Further, the generation unit 42 may generate changed information by changing a display aspect of the detection result regarding the predetermined target. For example, in a case where an image is acquired as the detected information, the generation unit 42 generates an image obtained by performing mosaic processing on the predetermined target, an image which displays only an outline of the predetermined target, or the like, as the changed information. In other words, the generation unit 42 generates changed information in which the predetermined target is obscured. Note that the generation unit 42 may generate changed information in which the predetermined target is highlighted.

Further, the generation unit 42 may generate changed information in which the detection result regarding the predetermined target is deleted from the detected information. For example, in a case where an image is acquired as the detected information, the generation unit 42 generates an image in which the target is deleted as the changed information.

Further, the generation unit 42 may generate changed information in which the detection result regarding the predetermined target is changed to information indicating a target different from the predetermined target. For example, the generation unit 42 generates changed information in which the predetermined target is changed to content regarding a target different from the predetermined target.

Further, in a case where the detected information includes a detection result regarding a target which satisfies conditions set by a predetermined setter, the generation unit 42 may generate changed information in which the detection result regarding the target is changed in the detected information. In other words, the generation unit 42 may generate changed information in which the detection result regarding the target is changed in the detected information in a case where context of the predetermined target satisfies the conditions set by the predetermined setter. For example, in a case where the detected information includes a detection result regarding a target which satisfies conditions indicated in the policy information set by the advertiser as a result of referring to the policy information database 31, the generation unit 42 generates changed information in which the detection result regarding the target is changed on the basis of the changed content indicated in the policy information.

Further, in a case where the detected information includes a detection result regarding an advertisement which satisfies conditions set by a predetermined setter, the generation unit 42 may generate changed information in which the detection result regarding the advertisement is changed in the detected information. In other words, the generation unit 42 may generate changed information in which the detection result regarding the target is changed in the detected information in a case where context of the predetermined target satisfies the conditions regarding an advertisement set by the predetermined setter. For example, in the example in FIG. 1, in a case where the image acquired from the terminal apparatus 100 includes the advertisement regarding the store #A, the generation unit 42 generates changed information in which the advertisement is changed in the image.

Further, the generation unit 42 may generate changed information in a case where the detected information acquired in an area set by a predetermined setter includes a detection result regarding an advertisement. In other words, the generation unit 42 may generate changed information in a case where context of a predetermined target satisfies the conditions regarding ab area set by the predetermined setter. For example, the generation unit 42 generates changed information in a case where the detected information acquired from the terminal apparatus 100 in an area indicated in the position condition of the policy information includes a detection result regarding a target indicated in the target condition of the policy information. To give a specific example, in the example in FIG. 1, the generation unit 42 generates changed information in a case where it is determined that the image acquired from the terminal apparatus 100 includes the advertisement #A, and the position where the image is captured is within a predetermined range from the store #B, and it is determined that a target which satisfies conditions indicated in the policy information of the advertisement #B is detected in the image.

Further, the generation unit 42 may generate changed information in a case where the detected information acquired in a period set by a predetermined setter includes a detection result regarding an advertisement. In other words, the generation unit 42 may generate changed information in a case where context of a predetermined target satisfies the conditions regarding a period set by the predetermined setter. For example, the generation unit 42 generates changed information in a case where the detected information acquired from the terminal apparatus 100 in a period indicated in the time condition of the policy information includes a detection result regarding a target indicated in the target condition of the policy information.

Note that the generation unit 42 may generate changed information in a case where the detected information acquired by a detection apparatus of a predetermined user includes a detection result regarding an advertisement which satisfies conditions set by a predetermined setter. For example, the generation unit 42 generates changed information in a case where the detected information acquired from the terminal apparatus 100 of a user corresponding to the user condition of the policy information includes a detection result regarding a target indicated in the target condition of the policy information.

Further, the generation unit 42 may generate changed information in which the detection result regarding the advertisement is changed to information indicating an advertisement different from the advertisement. In other words, the generation unit 42 may generate changed information in which the detection result regarding the advertisement is changed to an advertisement different from the advertisement in a case where the predetermined target is an advertisement having context which satisfies conditions set by the predetermined setter. For example, in the example in FIG. 1, the generation unit 42 generates an image AR2 in which the advertisement #A included in the image #2 is changed to an advertisement different from the advertisement #A.

Further, the generation unit 42 may generate changed information in which the detection result regarding the advertisement is changed to information indicating an advertisement which is different from the advertisement and which is provided by a predetermined setter. For example, in the example in FIG. 1, the generation unit 42 generates an image AR2 in which the advertisement #A included in the image #2 is changed to the advertisement #B provided by a manager of the store #B who sets the policy information.

Further, in a case where the detected information includes a detection result regarding an advertisement which satisfies conditions set by an advertiser determined in accordance with a bid result among advertisers who have bid for advertisement delivery for a predetermined detection apparatus, the generation unit 42 may generate changed information in which the detection result regarding the advertisement is changed in the detected information. For example, the generation unit 42 generates changed information by changing the detection result regarding the advertisement included in the detected information on the basis of policy information set by an advertiser who has bid at the highest amount among advertisers who have bid for advertisement delivery for the terminal apparatus 100. In other words, in a case where the detected information includes a detection result regarding an advertisement which satisfies conditions respectively set by a plurality of advertisers, the generation unit 42 generates changed information in which the detection result regarding the advertisement is changed on the basis of conditions (policy information) set by the advertiser who has bid for advertisement delivery for the terminal apparatus 100 at the highest amount among the plurality of advertisers.

Further, in a case where the image includes an image of a predetermined target, the generation unit 42 may generate an image in which the image of the predetermined target is changed as changed information. For example, in the example in FIG. 1, in a case where the image acquired from the terminal apparatus 100 includes the advertisement #A, the generation unit 42 generates an AR image in which the advertisement #A is changed.

Here, there may be desires to change various kinds of information other than an advertisement, which are not desired to be provided to the user. Thus, in a case where the detected information includes a detection result regarding a target which satisfies a predetermined condition, the generation unit 42 may generate changed information in which the detection result regarding the target is changed in the detected information. In other words, in a case where context of a predetermined target satisfies a predetermined condition, the generation unit 42 may generate changed information in which a detection result regarding the target is changed. For example, in a case where the detected information includes a detection result regarding a target which satisfies a condition corresponding to a position where the detected information is acquired, the generation unit 42 generates changed information in which the detection result regarding the target is changed in the detected information. To give a specific example, in a case where the detected information includes a detection result regarding a target which is against systems, regulations, and the like, set up by the autonomous community at a position where the detected information is acquired, the generation unit 42 generates changed information in which the detection result regarding the target is changed in the detected information.

Further, the generation unit 42 may generate changed information in a case where the detected information includes a detection result regarding a target which satisfies conditions in accordance with a user of a predetermined detection apparatus. In other words, the generation unit 42 may generate changed information in a case where context of a predetermined target satisfies the conditions in accordance with a user of a predetermined detection apparatus. For example, the generation unit 42 generates changed information in a case where the detected information includes a detection result regarding a target which satisfies conditions in accordance with a demographic attribute or a psychographic attribute of the user of the terminal apparatus 100. To give a specific example, the generation unit 42 generates changed information in a case where the detected information includes a detection result regarding a target indicating something the user is not good at or something the user dislikes (such as a target of allergy and targets of various kinds of phobia). Further, the generation unit 42 generates changed information in a case where the detected information includes a detection result regarding a target which is estimated as inappropriate on the basis of age of the user (such as, for example, content (such as a movie) for which rating of age above the age of the user is set and a target which is against the juvenile protection ordinance).

Provision Unit 43

The provision unit 43 provides the changed information to the user. For example, the provision unit 43 provides the changed information in which the detection result included in the detected information is changed to the user in place of the detected information.

Further, the provision unit 43 may provide an image set as the changed information to a display apparatus which is worn by the user and which causes the image to be displayed within sight of the user, as a display target. For example, in the example in FIG. 1, the provision unit 43 provides an AR image to the terminal apparatus 100 which is a spectacle type wearable device worn by the user.

### 3. Flow of Provision Processing

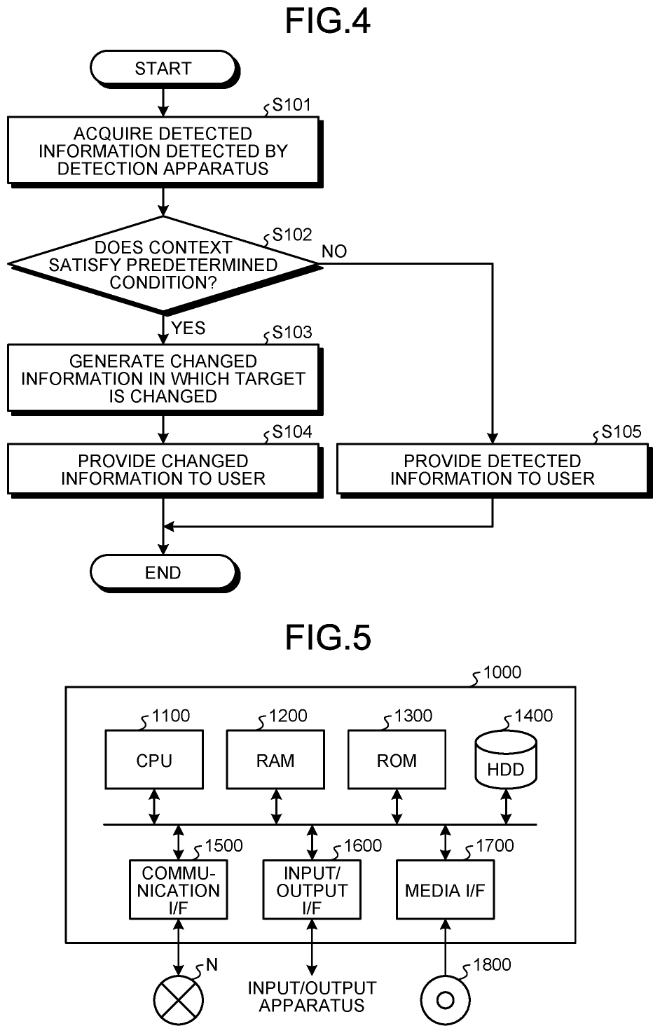

Procedure of the provision processing to be performed by the information provision apparatus 10 according to the embodiment will be described using FIG. 4. FIG. 4 is a flowchart illustrating an example of the procedure of the provision processing according to the embodiment.

As illustrated in FIG. 4, the information provision apparatus 10 acquires detected information detected by the detection apparatus (step S101). Subsequently, the information provision apparatus 10 determines whether or not context based on the detected information satisfies a predetermined condition (step S102). In a case where the context satisfies the predetermined condition (step S102; Yes), the information provision apparatus 10 generates changed information in which a target which satisfies the predetermined condition is changed (step S103). Subsequently, the information provision apparatus 10 provides the generated changed information to the user who uses the detection apparatus (step S104) and finishes the processing.

Meanwhile, in a case where the context does not satisfy the predetermined condition (step S102; No), the information provision apparatus 10 provides the detected information as is to the user (step S105) and finishes the processing.

### 4. Modified Examples

The above-described embodiment is merely an example, and various changes and application are possible.

4-1. Targets of Change

While an example has been described in the above-described embodiment where in a case where the detected information includes a detection result regarding an advertisement which satisfies conditions set by a predetermined setter, the generation unit 42 generates changed information in which the detection result regarding the advertisement is changed in the detected information, functions of the generation unit 42 are not limited to such an example. For example, in a case where the detected information includes information having predetermined relevance with an advertisement which satisfies the set conditions, the generation unit 42 may generate changed information in which the information is changed in the detected information. To give a specific example, the generation unit 42 generates changed information in which information indicated by an advertisement which satisfies conditions set by a predetermined setter (such as, for example, name of an article and an image of an article), information provided by the same advertiser as the advertiser of the advertisement, name of the advertiser, or the like, is changed in the detected information.

4-2. Medium on which Target to be Changed is Displayed

While an example has been described in the above-described embodiment where the generation unit 42 generates changed information in which an advertisement (digital content) displayed on a digital signage is changed in the detected information, functions of the generation unit 42 are not limited to such an example, and the generation unit 42 may generate changed information by changing various kinds of information displayed on various kinds of media. For example, the generation unit 42 may generate changed information by changing information displayed on various kinds of media such as a sign, a banner-flag, a building and a mobile object (such as a vehicle).

4-3. Detected Information

While an example has been described in the above-described embodiment where in a case where the image detected by the terminal apparatus 100 includes a detection result regarding a predetermined target, the generation unit 42 generates an image in which the detection result regarding the predetermined target is changed in the image as changed information, functions of the generation unit 42 are not limited to such an example. For example, the generation unit 42 may generate changed information by changing speech included in the detected information detected by the terminal apparatus 100. To give a specific example, in a case where the detected information includes a detection result regarding speech which satisfies conditions set by an advertiser (for example, speech regarding advertisements of other advertisers), the generation unit 42 generates changed information in which the detection result regarding the speech is changed in the detected information. To give a more specific example, the generation unit 42 generates changed information in which target speech is reduced (subjected to noise cancellation), changed information in which speech set by the advertiser is synthesized in place of the target speech, or the like.

4-4. Changed Information

While an example has been described in the above-described embodiment where in a case where the detected information includes a detection result regarding a target which satisfies conditions set by an advertiser, the generation unit 42 generates changed information in which the detection result regarding the target is changed in the detected information, functions of the generation unit 42 are not limited to such an example. For example, even in a case where the detected information includes a detection result regarding a target which satisfies conditions set by an advertiser, the generation unit 42 does not have to change the detection result. To give a specific example, an advertiser of an advertisement included in the detected information detected by the terminal apparatus 100 (hereinafter, sometimes described as an “advertiser #1”) and an advertiser who desires to change the advertisement (hereinafter, sometimes described as an “advertiser #2”) submit bids for advertisement delivery for the terminal apparatus 100, and in a case where the bid by the advertiser #1 is higher, the generation unit 42 does not generate changed information. In other words, the detected information is displayed as is at the terminal apparatus 100. Meanwhile, in a case where the bid by the advertiser #2 is higher, the generation unit 42 generates changed information in which the detection result regarding the advertisement of the advertiser #1 is changed in the detected information on the basis of policy information set by the advertiser #2.

4-5. Processing Aspects

All or part of processing described as being automatically performed among the processing described in the above embodiment can be manually performed, or conversely, all or part of processing described as being manually performed can be automatically performed using a publicly known method. In addition, information including processing procedure, specific name, various kinds of data and parameters described in the above specification and illustrated in the drawings can be arbitrarily changed unless otherwise described. For example, various kinds of information illustrated in the respective drawings are not limited to the illustrated information.

Further, the illustrated respective components of the respective apparatuses are conceptual functional components, and do not necessarily require to be physically constituted as illustrated. In other words, specific forms of distribution and integration of respective apparatuses are not limited to that illustrated and, all or part of the apparatuses may be functionally or physically distributed or integrated in an arbitrary unit in accordance with various kinds of loads, statuses of use, or the like.

Further, each embodiment described above can be combined as appropriate within a range not causing inconsistency in processing content.

### 5. Effects

As described above, the information provision apparatus 10 according to the embodiment includes the acquisition unit 41, the generation unit 42, and the provision unit 43. The acquisition unit 41 acquires detected information based on information detected by a predetermined detection apparatus. Further, the acquisition unit 41 acquires a captured image of a target included in the user's field of view as the detected information. In other words, in a case where context based on the detected information satisfies a predetermined condition, the generation unit 42 generates changed information in which the detection result regarding the predetermined target is changed in the detected information. Further, in a case where the image includes an image of a predetermined target, the generation unit 42 generates an image in which the image of the predetermined target is changed as changed information. The provision unit 43 provides the changed information to the user. Further, the provision unit 43 provides an image set as the changed information to a display apparatus which is worn by the user and which causes the image to be displayed within sight of the user, as a display target.

This enables the information provision apparatus 10 according to the embodiment to arbitrarily change display content of an advertisement on the basis of the conditions set by the advertiser in augmented reality even if the display content of the advertisement is fixed in the real world, and provide the display content to the user, so that it is possible to provide appropriate information in accordance with policy of the advertiser to the user.

Further, the generation unit 42 of the information provision apparatus 10 according to the embodiment, for example, generates changed information in which a display aspect of a detection result regarding a predetermined target is changed. Further, the generation unit 42 generates changed information in which a detection result regarding a predetermined target is deleted from the detected information. Further, the generation unit 42 generates changed information in which a detection result regarding a predetermined target is changed to information indicating a target different from the predetermined target. Further, in a case where context of a predetermined target satisfies a predetermined condition, the generation unit 42 generates changed information in which a detection result regarding the target is changed. Further, in a case where the predetermined target is an advertisement having context which satisfies conditions set by the predetermined setter, the generation unit 42 generates changed information in which the detection result regarding the advertisement is changed to information indicating an advertisement different from the advertisement. Further, the generation unit 42 generates changed information in which the detection result regarding the advertisement is changed to information indicating an advertisement which is different from the advertisement and which is provided by the predetermined setter.

This enables the information provision apparatus 10 according to the embodiment to change a target which satisfies conditions in various aspects and provide information to the user, so that it is possible to provide appropriate information in accordance with policy of the advertiser to the user.

Further, the generation unit 42 of the information provision apparatus 10 according to the embodiment, for example, generates changed information in a case where context of a predetermined target satisfies conditions in accordance with a user of a predetermined detection apparatus. Further, in a case where context of a predetermined target satisfies conditions set by a predetermined setter, the generation unit 42 generates changed information in which the detection result regarding the target is changed in the detected information. Further, in a case where context of a predetermined target satisfies conditions regarding an advertisement set by a predetermined setter, the generation unit 42 generates changed information in which the detection result regarding the target is changed in the detected information. Further, the generation unit 42 generates changed information in a case where context of a predetermined target satisfies a condition regarding an area set by a predetermined setter. Further, the generation unit 42 generates changed information in a case where context of a predetermined target satisfies a condition regarding a period set by a predetermined setter. Further, in a case where the detected information includes a detection result regarding an advertisement which satisfies conditions set by an advertiser determined in accordance with a bid result among advertisers who have bid for advertisement delivery for a predetermined detection apparatus, the generation unit 42 generates changed information in which the detection result regarding the advertisement is changed in the detected information.

This enables the information provision apparatus 10 according to the embodiment to specify a target in accordance with various conditions and provide the changed information to the user, so that it is possible to provide appropriate information in accordance with policy of the advertiser to the user.

### 6. Hardware Configuration

Further, the information provision apparatus 10 according to each embodiment described above is implemented with, for example, a computer 1000 having a configuration as illustrated in FIG. 5. Hereinafter, an example of the information provision apparatus 10 will be described. FIG. 5 is a hardware configuration diagram illustrating an example of a computer which implements functions of the information provision apparatus. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of a program stored in the ROM 1300 or the HDD 1400 and controls respective units. The ROM 1300 stores a boot program to be executed by the CPU 1100 upon start-up of the computer 1000, a program dependent on hardware of the computer 1000, and the like.

The HDD 1400 stores a program to be executed by the CPU 1100, data to be used by the program, and the like. The communication interface 1500 receives data from other equipment via a communication network 500 (corresponding to the network N of the embodiments) and transmits the data to the CPU 1100, and transmits data generated by the CPU 1100 to other equipment via the communication network 500.

The CPU 1100 controls an output apparatus such as a display and a printer and an input apparatus such as a keyboard and a mouse via the input/output interface 1600. The CPU 1100 acquires data from the input apparatus via the input/output interface 1600. Further, the CPU 1100 outputs data generated via the input/output interface 1600 to the output apparatus.

The media interface 1700 reads a program or data stored in a recording medium 1800 and provides the program or the data to the CPU 1100 via the RAM 1200. The CPU 1100 loads the program on the RAM 1200 from the recording medium 1800 via the media interface 1700 and executes the loaded program. The recording medium 1800 is, for example, an optical recording medium such as a digital versatile disc (DVD) and a phase change rewritable disk (PD), a magnetooptical recording medium such as a magneto-optical disk (MO), a tape medium, a magnetic recording medium or a semiconductor memory.

For example, in a case where the computer 1000 functions as the information provision apparatus 10, the CPU 1100 of the computer 1000 implements functions of the control unit 40 by executing the program loaded on the RAM 1200. Further, each data of the storage device inside the information provision apparatus 10 is stored in the HDD 1400. While the CPU 1100 of the computer 1000 reads the program from the recording medium 1800 and executes the program, the CPU 1100 may acquire the program from other apparatuses via a predetermined communication network as another example.

### 7. Others

While some of the embodiments of the present application have been described in detail above on the basis of the drawings, these are provided for illustrative purposes, and the present invention can be implemented in other forms in which various changes and modifications are made on the basis of knowledge of a person skilled in the art, including the aspects described in disclosure of the invention.

Further, a configuration of the above-described information provision apparatus 10 can be flexibly changed such that an external platform, or the like, is invoked through an application programming interface (API), network computing, or the like, and implemented depending on functions.

Further, “unit” described in the claims can read “means”, “circuit”, or the like. For example, the acquisition unit can read acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A provision apparatus comprising:
an acquisition unit configured to acquire detected information based on information detected by a predetermined detection apparatus;
a generation unit configured to generate changed information in which a detection result regarding a predetermined target is changed in the detected information in a case where context based on the detected information satisfies a predetermined condition; and
a provision unit configured to provide the changed information to a user.

2. The provision apparatus according to claim 1,
wherein the generation unit
generates the changed information in which a display aspect of the detection result regarding the predetermined target is changed.

3. The provision apparatus according to claim 1,
wherein the generation unit
generates the changed information in which the detection result regarding the predetermined target is deleted from the detected information.

4. The provision apparatus according to claim 1,
wherein the generation unit
generates the changed information in which the detection result regarding the predetermined target is changed to information indicating a target different from the predetermined target.

5. The provision apparatus according to claim 1,
wherein the generation unit
generates the changed information in which the detection result regarding the target is changed in a case where context of the predetermined target satisfies the predetermined condition.

6. The provision apparatus according to claim 5,
wherein the generation unit
generates the changed information in a case where the context of the predetermined target satisfies a condition in accordance with a user of the predetermined detection apparatus.

7. The provision apparatus according to claim 5,
wherein, in a case where the context of a predetermined target satisfies a condition set by a predetermined setter, the generation unit
generates the changed information in which the detection result regarding the target is changed in the detected information.

8. The provision apparatus according to claim 7,
wherein, in a case where the context of a predetermined target satisfies a condition regarding an advertisement set by the predetermined setter, the generation unit
generates changed information in which a detection result regarding the advertisement is changed in the detected information.

9. The provision apparatus according to claim 7,
wherein the generation unit
generates the changed information in a case where the context of the predetermined target satisfies a condition regarding an area set by the predetermined setter.

10. The provision apparatus according to claim 7,
wherein the generation unit
generates the changed information in a case where the context of the predetermined target satisfies a condition regarding a period set by the predetermined setter.

11. The provision apparatus according to claim 7,
wherein in a case where the predetermined target is an advertisement having context which satisfies the condition set by the predetermined setter, the generation unit generates the changed information in which the detection result regarding the advertisement is changed to information indicating an advertisement different from the advertisement.

12. The provision apparatus according to claim 11,
wherein the generation unit
generates the changed information in which the detection result regarding the advertisement is changed to information indicating an advertisement which is different from the advertisement and which is provided by the predetermined setter.

13. The provision apparatus according to claim 11,
wherein in a case where the detected information includes a detection result regarding an advertisement which satisfies a condition set by an advertiser determined in accordance with a bid result among advertisers who have bid for advertisement delivery for the predetermined detection apparatus, the generation unit generates the changed information in which the detection result regarding the advertisement is changed in the detected information.

14. The provision apparatus according to claim 1,
wherein the acquisition unit
acquires a captured image of a target included in a field of view of a user as the detected information,
in a case where the image includes an image of a predetermined target, the generation unit
generates an image in which the image of the predetermined target is changed as the changed information, and
the provision unit
provides the image set as the changed information to a display apparatus which is worn by the user and which causes an image to be displayed within sight of the user, as a display target.

15. A provision method to be executed by a computer, comprising:
acquiring detected information based on information detected by a predetermined detection apparatus;
generating changed information in which a detection result regarding a predetermined target is changed in the detected information in a case where context based on the detected information satisfies a predetermined condition; and
providing the changed information to a user.

16. A non-transitory computer readable storage medium having stored therein a provision program for causing a computer to execute:
acquisition procedure of acquiring detected information based on information detected by a predetermined detection apparatus;
generation procedure of generating changed information in which a detection result regarding a predetermined target is changed in the detected information in a case where context based on the detected information satisfies a predetermined condition; and
provision procedure of providing the changed information to a user.
